(19) United States
(12) Patent Application Publication
(10) Pub. No.: US 2020/0122469 A1
(43) Pub. Date: Apr. 23, 2020

(54) RECORDING HEAD MAINTENANCE DEVICE AND INKJET RECORDING APPARATUS THEREWITH

(71) Applicant: KYOCERA Document Solutions Inc., Osaka (JP)

(72) Inventors: Yuzo ONISHI, Osaka (JP); Yasuyuki FUKUNAGA, Osaka (JP)

(73) Assignee: KYOCERA Document Solutions Inc., Osaka (JP)

(21) Appl. No.: 16/657,061

(22) Filed: Oct. 18, 2019

(30) Foreign Application Priority Data
Oct. 22, 2018 (JP) 2018-198074

(51) Int. Cl. B41J 2/165

(52) U.S. Cl. CPC B41J 2/16538; B41J 2202/20; B41J 2/16508; B41J 2/16547

(57) ABSTRACT

A recording head maintenance device has a wiper, a blade unit, a wiper carriage, a supporting frame, a wiper moving mechanism, and a unit lifting mechanism. The wiper carriage includes a carriage body in a flat-plate shape, a pair of rail portions provided at both side end parts of the carriage body that are parallel to the movement direction of the wiper carriage, positioning pins protruding horizontally from the inner side faces of the rail portions respectively, positioning pulleys provided rotatably on the rail portions respectively and making contact with a head housing holding the recording head, thereby to keep the gap between the wiper and the ink ejection surface constant. The blade unit has, on both its side faces facing the rail portions, engagement portions that engage with the positioning pins to hold the positioning pins from above and below.

### INCORPORATION BY REFERENCE

This application is based upon and claims the benefit of priority from the corresponding Japanese Patent Application No. 2018-198074 filed on Oct. 22, 2018, the entire contents of which are incorporated herein by reference.

### BACKGROUND

The present disclosure relates to a maintenance device for a recording head, as is incorporated in an inkjet recording apparatus, that is, one that performs recording by ejecting ink onto a recording medium, for the purpose of horizontally moving a wiper for wiping the ink ejection surface of the recording head.

As one type of recording apparatuses such as facsimile machines, copiers, and printers, inkjet recording apparatuses, which form an image by ejecting ink onto a recording medium such as paper and OHP sheets, are widely used because of the high precision of the images that they produce.

In those inkjet recording apparatuses, generally, drying-up of ink inside ink ejection nozzles that have openings on the ink ejection surface of the recording head, and hence clogging in the nozzles, is prevented by forcibly ejecting (purging) ink out of the nozzles. Ejecting ink in that way helps discharge ink with increased viscosity, air bubbles, foreign matter, and the like out of the nozzles. Also, the ink so ejected helps re-dissolve the mist (ink residue) adhered to the ink ejection surface.

After ink is ejected, the ink adhered to the ink ejection surface (nozzle surface) is wiped off with a blade-form wiper, and in this way, recovery of the recording head is achieved. The wiper is formed of an elastic material such as rubber, and by elastically deforming the wiper and pressing it against the ink ejection surface, it is possible to wipe off ink while keeping the wiper in close contact with the ink ejection surface with no gap between them.

For example, in one known inkjet recording apparatus, a carriage in a substantially rectangular shape having a plurality of wipers fixed to it is, together with a supporting frame that supports it, moved up and down by a lifting mechanism, and the carriage is moved horizontally with respect to the supporting frame, so that the ink ejection surface of a plurality of recording heads constituting a line head is wiped in one operation.

### SUMMARY

According to one aspect of the present disclosure, a recording head maintenance device includes a wiper, a blade unit, a wiper carriage, a supporting frame, a wiper moving mechanism, and a unit lifting mechanism, and performs the wiping of the ink ejection surface by making the wiper carriage reciprocate and move up and down. The wiper wipes the ink ejection surface of a recording head that ejects ink onto a recording medium. The blade unit has the wiper fixed to it. The wiper carriage which supports the blade unit such that the blade unit is attachable and detachable in the horizontal direction. The supporting frame supports the wiper carriage such that the wiper carriage is movable in the horizontal direction. The wiper moving mechanism makes the wiper carriage reciprocate along the supporting frame. The unit lifting mechanism makes the supporting frame together with the wiper carriage move up and down in the directions approaching and receding from the ink ejection surface. The wiper carriage includes a carriage body in a flat-plate shape, a pair of rail portions provided at both side end parts of the carriage body that are parallel to the movement direction of the wiper carriage, positioning pins protruding horizontally from the inner side faces of the pair of rail portions respectively, positioning pulleys provided rotatably on the pair of rail portions respectively and making contact with a head housing holding the recording head thereby to keep a gap between the wiper and the ink ejection surface constant. The blade unit has, on both its side faces facing the pair of rail portions, engagement portions that engage with the positioning pins so as to hold the positioning pins from above and below.

This and other objects of the present disclosure, and the specific benefits obtained according to the present disclosure, will become apparent from the description of embodiments which follows.

### BRIEF DESCRIPTION OF THE DRAWINGS

FIG. 1 is a diagram showing a structure of an inkjet printer incorporating a maintenance unit according to the present disclosure;

FIG. 2 is a diagram showing a first belt conveying portion and a recording portion of the printer as seen from above;

FIG. 3 is a diagram showing a structure of the recording portion of the printer;

FIG. 4 is a diagram showing a structure of a recording head provided in a line head in the recording portion of the printer;

FIG. 5 is a diagram showing a recording head in the printer as seen from the ink ejection surface side;

FIG. 6 is a diagram showing a structure of the recording portion, a cap unit, the maintenance unit, etc. in the printer;

FIG. 7 is a diagram showing a structure of the cap unit in the printer;

FIG. 8 is a perspective view showing a structure of a carriage in the printer, showing a state where supporting arms are laid flat;

FIG. 9 is a perspective view showing the structure of the carriage in the printer, showing a state where the supporting arms are raised;

FIG. 10 is an enlarged view, as seen from above, of a maintenance unit according to a first embodiment of the present disclosure for incorporation in a printer;

FIG. 11 is a sectional view showing a structure of a driving part of the maintenance unit;

FIG. 12 is a perspective view of a blade unit provided in the maintenance unit according to the first embodiment;

FIG. 13 is a perspective view of a wiper carriage provided in the maintenance unit according to the first embodiment:

FIG. 14 is a diagram showing a state where the first belt conveying portion is lowered;

FIG. 15 is a diagram showing a state where the maintenance unit in the printer has been moved to a first position;

FIG. 16 is a diagram showing a state where a wiper in the printer is kept in pressed contact with a wiping start position on an ink ejection surface of the recording head;

FIG. 17 is a diagram showing a state where the wiper in the printer is wiping purged ink ejected onto the ink ejection surface of the recording head;

FIG. 18 is a diagram showing a state where the cap unit and the maintenance unit in the printer have been moved to the first position;

FIG. 19 is a side sectional view showing a state where the blade unit is in the process of being fitted to the wiper carriage in the maintenance unit according to the first embodiment;

FIG. 20 is a side sectional view showing a state where the fitting of the blade unit to the wiper carriage is complete in the maintenance unit according to the first embodiment;

FIG. 21 is a side sectional view showing a state where the blade unit is in the process of being fitted to the wiper carriage in the maintenance unit according to a second embodiment of the present disclosure; and

FIG. 22 is a side sectional view showing a state where the fitting of the blade unit to the wiper carriage is complete in the maintenance unit according to the second embodiment.

### DETAILED DESCRIPTION

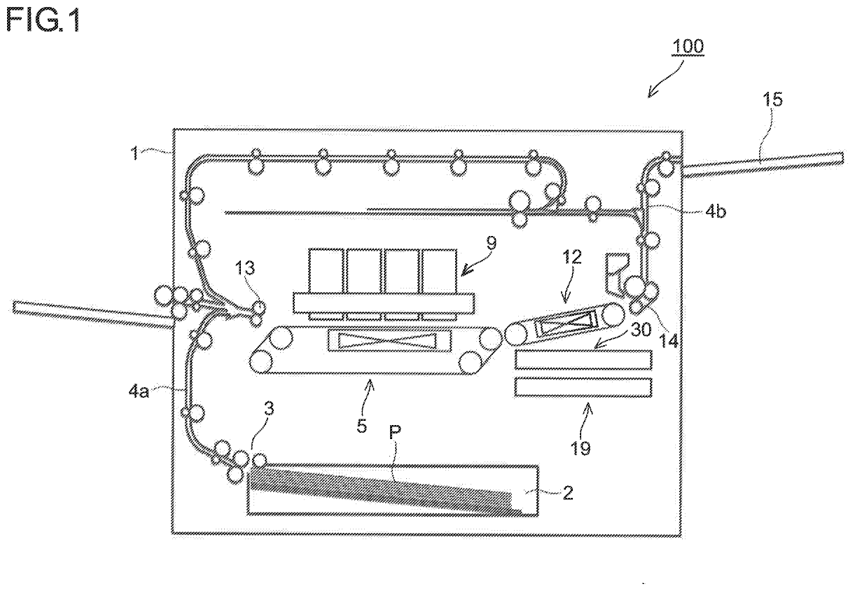

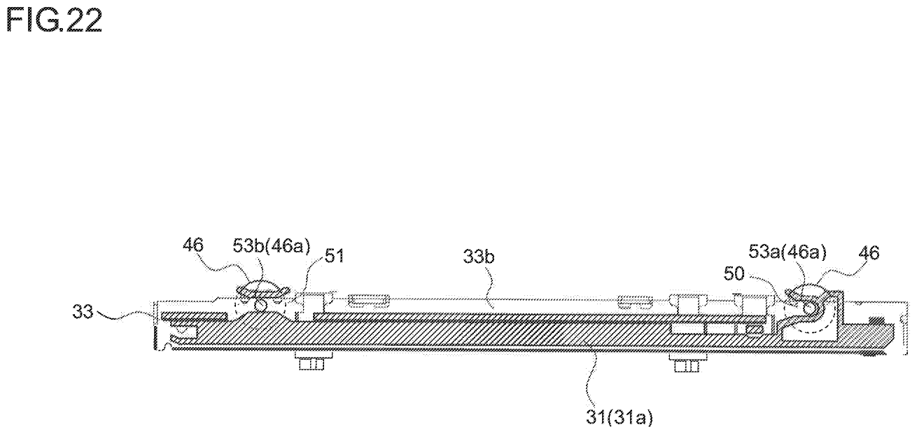

Hereinafter, with reference to FIGS. 1 to 22, an inkjet printer 100 (inkjet recording apparatus; hereinafter referred to as a printer 100) incorporating a maintenance unit 19 according to the present disclosure will be described. As shown in FIG. 1, in the printer, in a lower part inside a printer main body 1, a sheet feed cassette 2, which serves as a sheet storage portion, is arranged. In the sheet feed cassette 2, sheets P, as an example of a recording medium, are stored. On the downstream side of the sheet feed cassette 2 in the sheet conveying direction, that is, over the left side of the sheet feed cassette 2 in FIG. 1, a sheet feeding device 3 is arranged. The sheet feeding device 3 separates and feeds out sheets P one by one toward the upper left of the sheet feed cassette 2 in FIG. 1.

The printer 100 has, inside it, a first sheet conveying passage 4a. The first sheet conveying passage 4a is located to the upper left, which is the sheet feeding direction of the sheet feed cassette 2. A sheet P fed out from the sheet feed cassette 2 is conveyed vertically upward along a side face of the printer main body 1 by the first sheet conveying passage 4a.

On the downstream end of the first sheet conveying passage 4a in the sheet conveying direction, a registration roller pair 13 is arranged. Close to the downstream side of the registration roller pair 13 in the sheet conveying direction, a first belt conveying portion 5 and a recording portion 9 are arranged. The sheet P fed out from the sheet feed cassette 2 reaches the registration roller pair 13 through the first sheet conveying passage 4a. The registration roller pair 13 stops the sheet P temporarily to correct it skewed feeding and then feeds out the sheet P again toward the first belt conveying portion 5 with timing coordinated with ink ejection operation performed by the recording portion 9.

On the downstream side (in FIG. 1, the right side) of the first belt conveying portion 5 in the sheet conveying direction, a second belt conveying portion 12 is arranged. A sheet P having an ink image recorded to it in the recording portion 9 is fed to the second belt conveying portion 12, and while it passes through the second belt conveying portion 12, the ink ejected onto the surface of the sheet P is dried.

On the downstream side of the second belt conveying portion 12 in the sheet conveying portion, near the right side face of the printer main body 1, a decurler portion 14 is arranged. A sheet P having ink dried in the second belt conveying portion 12 is fed to the decurler portion 14, and a curl in the sheet P is corrected by a plurality of rollers arrayed in the sheet width direction.

On the downstream side of (in FIG. 1, above) the decurler portion 14 in the sheet conveying direction, a second sheet conveying passage 4b is arranged. When no duplex recording is performed, a sheet P having passed through the decurler portion 14 is discharged from the second sheet conveying passage 4b via a discharge roller pair onto a sheet discharge tray 15 provided outside the right side face of the printer 100.

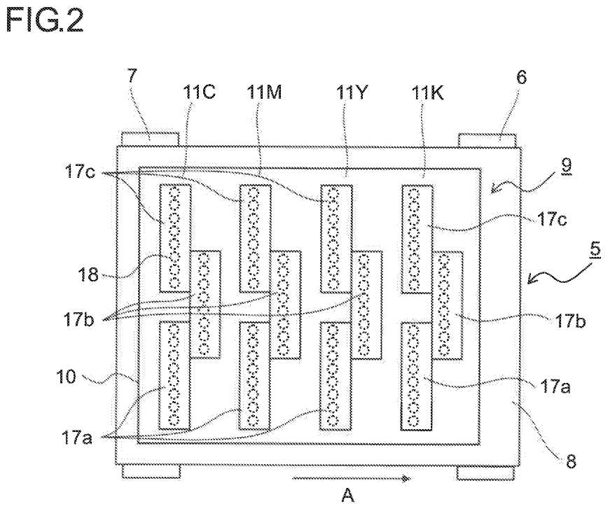

Under the second belt conveying portion 12, a maintenance unit 19 and a cap unit 30 are arranged. When performing a purge, which will be described later, the maintenance unit 19 moves horizontally to under the recording portion 9, where the maintenance unit 19 wipes off ink ejected from ejection nozzles 18 (see FIG. 2) of recording heads 17a to 17c, which will be described later, and collects the ink wiped off. When performing capping on ink ejection surfaces F (see FIG. 4) of the recording heads 17a to 17c, the cap unit 30 moves horizontally to under the recording portion 9, and then moves upward to be attached to the bottom face of the recording heads 17a to 17c.

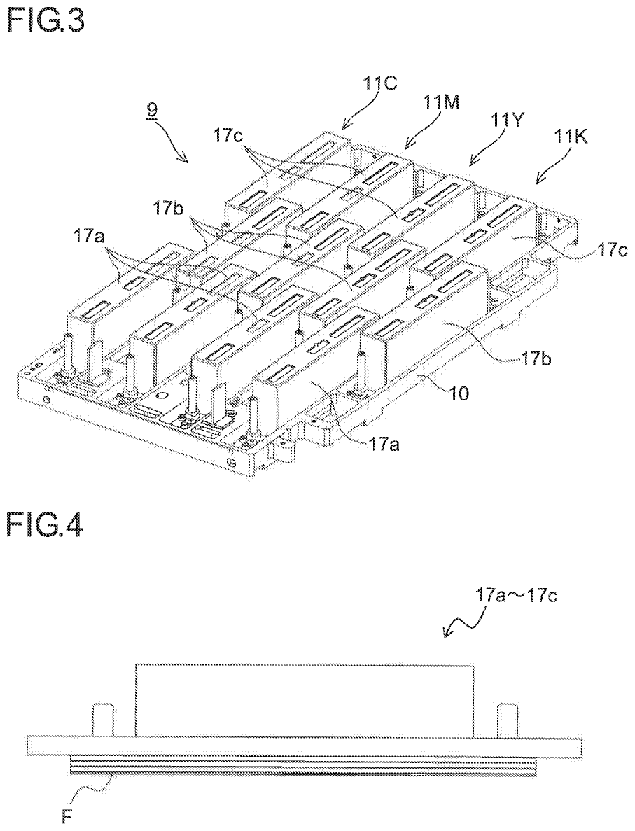

As shown in FIGS. 2 and 3, the recording portion 9 includes a head housing 10 and line heads 11C, 11M, 11Y, and 11K held on the head housing 10. These line heads 11C to 11K are supported at such a height as to form a predetermined gap (for example, 1 mm) from a conveying face of a first conveying belt 8 wound around a plurality of rollers including a driving roller 6 and a following roller 7, and a plurality of (here, three) recording heads 17a to 17c are arrayed in a zigzag along the sheet width direction (in FIG. 2, the up-down direction) perpendicular to the sheet conveying direction (the direction indicated by arrow A). The line heads 11C to 11K have a recording region equal to or larger than the width of the sheet P conveyed, and ejects aqueous ink (hereinafter referred to simply as ink) from the ejection nozzles 18 corresponding to a printing position to a sheet P that is conveyed by the first conveying belt 8.

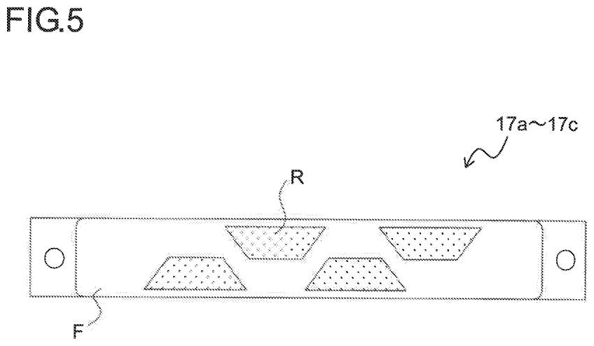

As shown in FIG. 5, in the ink ejection surface F of the recording heads 17a to 17c, there is arranged a nozzle region R in which a large number of ejection nozzles 18 are arrayed. On the ink ejection surface F, water repellent film (unillustrated) is formed. The recording heads 17a to 17c have the same shape and configuration, and thus one of the recording heads 17a to 17c is shown in FIGS. 4 and 5.

The recording heads 17a to 17c constituting the line heads 11C to 11K are fed respectively with ink of four colors (cyan, magenta, yellow, and black) stored n respective ink tanks (unillustrated).

Based on image data received from an external computer, the recording heads 17a to 17c eject ink from the ejection nozzles 18 toward a sheet P conveyed in a state held by suction on the conveying face of the first conveying belt 8. Thus, on the sheet P on the first conveying belt 8, a color image is formed that has ink of four colors, namely cyan, magenta, yellow, and black, overlaid together.

To prevent ink ejection failure due to drying and clogging in the recording heads 17a to 17c, a purge is performed to eject ink with increased viscosity in the nozzles from the ejection nozzles 18 of all the recording heads 17a to 17c at the start of printing after a long pause, or from the ejection nozzles 18 of the recording heads 17a to 17c of which have ejected an amount of ink equal to or less than a predetermined value between printing operations, in preparation for a subsequent printing operation.

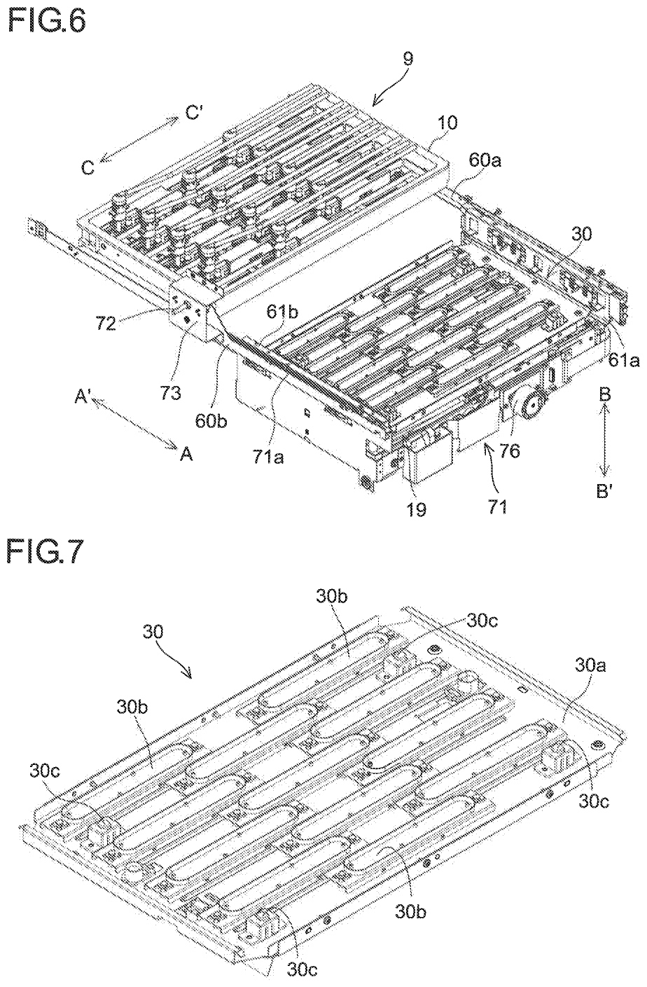

As shown in FIG. 6, under the recording portion 9, two guide rails 60a and 60b are fixed along opposite end parts parallel to the sheet conveying direction (the direction indicated by arrow A). To the guide rails 60a and 60b, a pair of guide plates 61a and 61b is fixed, and on lower end parts of the guide plates 61a and 61b, side edges of the cap unit 30 are supported. On the guide rails 60a and 60b, a carriage 71 is slidably supported, and on the carriage 71, the maintenance unit 19 is placed.

The cap unit 30 is reciprocatable between a first position (the position shown in FIG. 18) right under the recording portion 9 and a second position (the position shown in FIG. 6) where the cap unit 30 is retracted in the horizontal direction (the direction indicated by arrow A) from the first position, and is configured to cap the recording heads 17a to 17c by moving up in the first position.

Specifically, as shown in FIG. 7, the cap unit 30 includes a cap tray 30a which is made of sheet metal, twelve cap parts 30b, each in a concave shape, arranged on the top face of the cap tray 30a, and four height direction positioning protrusions 30c.

The cap parts 30b are arranged at positions corresponding to the recording heads 17a to 17c. Thus, by moving the cap unit 30 up in the first position, the cap parts 30b cap the ink ejection surfaces F of the recording heads 17a to 17c. When the cap unit 30 is raised to the recording portion 9 side to cap the recording heads 17a to 17c, the height direction positioning protrusions 30c make contact with the housing 10 of the recording portion 9 and thereby keep a predetermined contact state between the cap parts 30b and the ink ejection surfaces F.

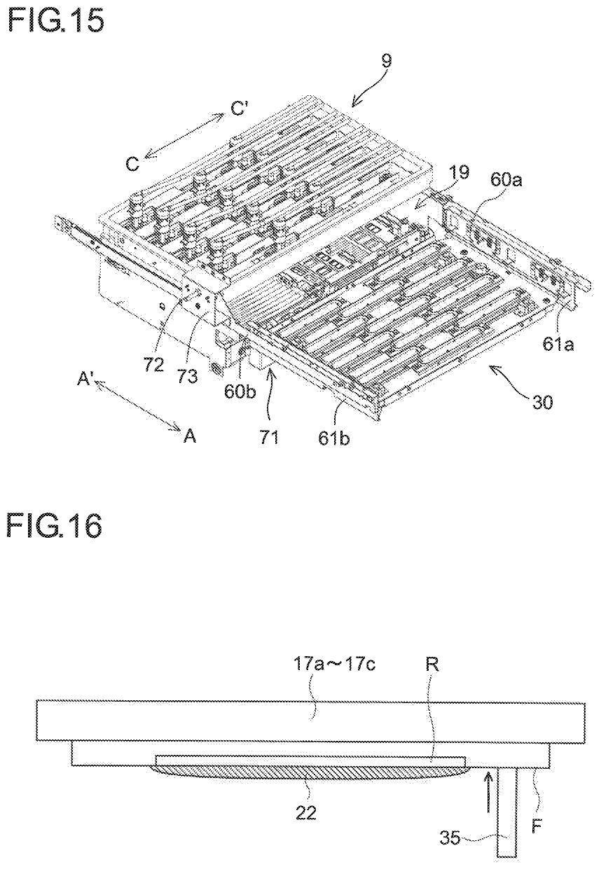

The maintenance unit 19 is reciprocatable between a first position (the position shown in FIG. 15) right under the recording portion 9 and a second position (the position shown in FIG. 6) where the maintenance unit 19 is retracted in the horizontal direction (the direction indicated by arrow A) from the first position, and is configured to perform a wiping operation, which will be described later, by moving up in the first position.

Specifically, outside the guide rail 60b, there are attached a driving motor 72 for moving the carriage 71 in the direction indicated by arrows A and A′, a gear train (unillustrated) which engages with the driving motor 72 and rack teeth 71a on the carriage 71, and a cover member 73 which covers those components. As the driving motor 72 rotates forward, the gear train rotates, so that the carriage 71 and the maintenance unit 19 move from the second position to the first position. The driving motor 72, the gear train, and the like constitute a unit moving mechanism which moves the maintenance unit 19 in the horizontal direction.

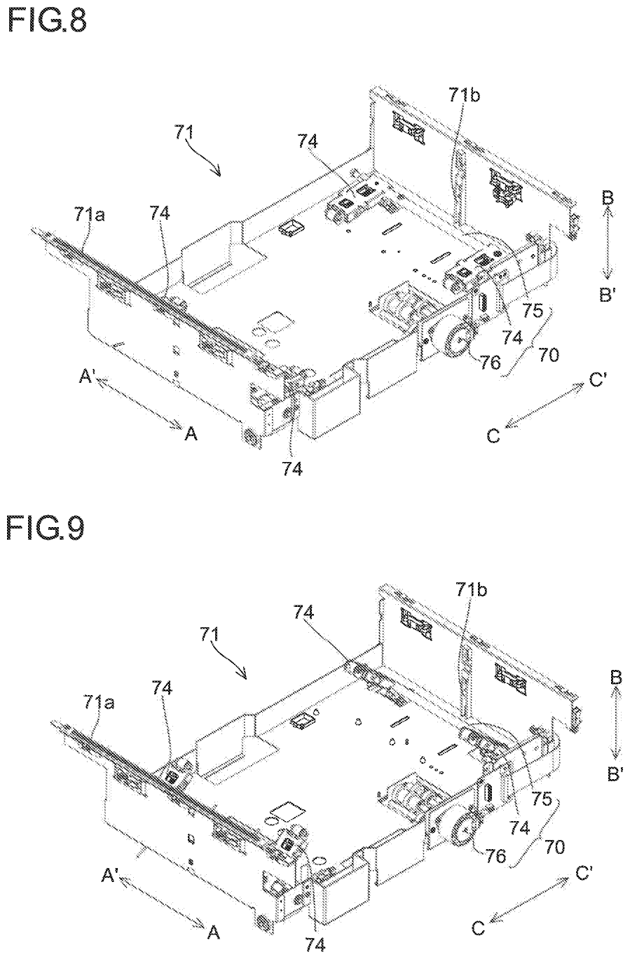

In the four corners of the carriage 71, as shown in FIGS. 8 and 9, supporting arms 74 are provided which support the maintenance unit 19 from its bottom face side and which are swingable (laid flat or raised). The supporting arms 74 adjacent to each other in the direction indicated by arrows A and A′ are coupled together by a rotary shaft 75. Outside the carriage 71, there are attached a wipe lifting motor 76 for swinging the supporting arms 74 and a gear train or the like (unillustrated) which engages with the wipe lifting motor 76 and with a gear of the rotary shaft 75. As the wipe lifting motor 76 rotates forward, the gear train or the like rotates, and thus the rotary shaft 75 rotates, so that the supporting arms 74 swing (become raised). Thus, the maintenance unit 19 moves up. The wipe lifting motor 76, the gear train, the rotary shaft 75, the supporting arms 74, and the like constitute a unit lifting mechanism 70 which moves the maintenance unit 19 in the up-down direction (the direction indicated by arrows B and B′). On the inner surface of the carriage 71, a guide groove 71b extending in the up-down direction is formed, and the maintenance unit 19 moves up and down along the guide groove 71b.

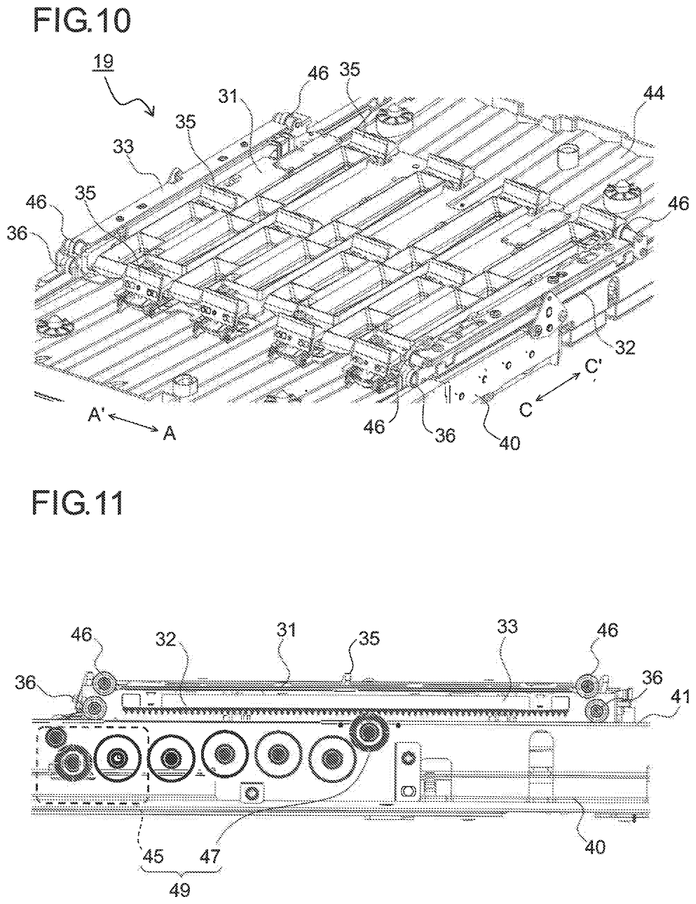

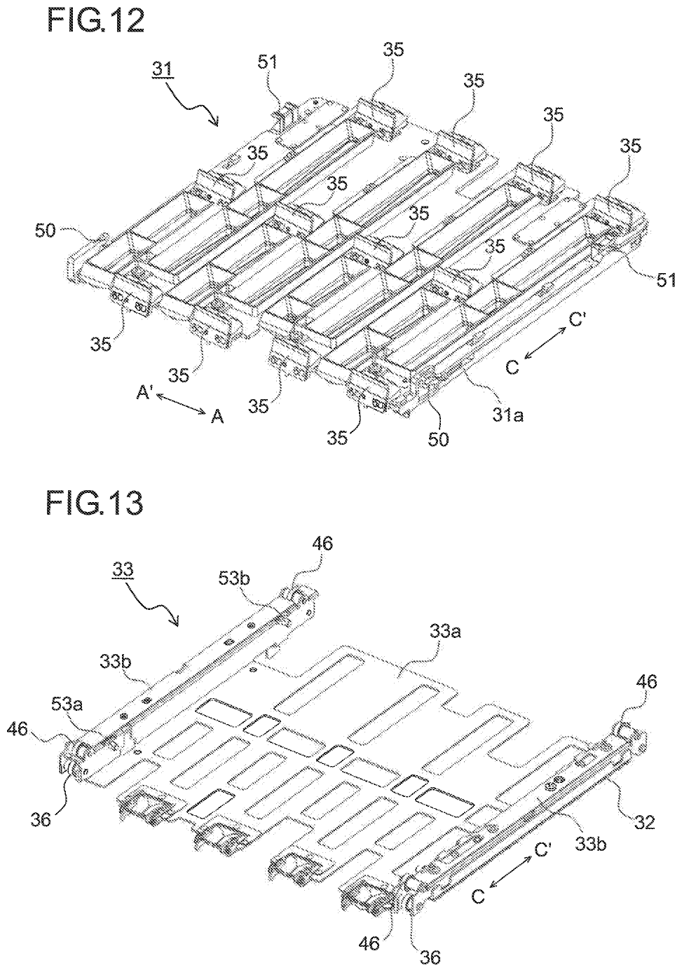

FIG. 10 is an enlarged view, as seen from above, of the maintenance unit 19 according to a first embodiment of the present disclosure incorporated in the printer 100. FIG. 11 is a sectional view showing a structure of a driving part of the maintenance unit 19 according to the first embodiment. FIGS. 12 and 13 are perspective views of a blade unit 31 and a wiper carriage 33 respectively constituting the maintenance unit 19 according to the first embodiment. The maintenance unit 19 is composed of a blade unit 31 to which a plurality of wipers (wipe blades) 35 are fixed, a substantially rectangular wiper carriage 33 to which the blade unit 31 is fitted, and a supporting frame 40 which supports the wiper carriage 33.

As shown in FIGS. 10 and 11, in opposite end edges of the top face of the supporting frame 40, rail grooves 41 are formed. Slide pulleys 36 provided at four places on the wiper carriage 33 make contact with the rail grooves 41, and thus the wiper carriage 33 is supported on the supporting frame 40 so as to be slidable in the direction indicated by arrows C and C′.

To the supporting frame 40, there are fitted a wiper driving motor 45 for moving the wiper carriage 33 in the horizontal direction (the direction indicated by arrows C and C′) and a rack driving gear 47 which engages with a rack 32 on the wiper carriage 33. As the wiper driving motor 45 rotates forward and backward, a rack driving gear 47 rotates forward and backward via the gear train, so that the wiper carriage 33 reciprocates in the horizontal direction (the direction indicated by arrows C and C′). The wiper driving motor 45, the rack driving gear 47, and the like constitute a wiper moving mechanism 49 which moves the wipers 35 along the ink ejection surfaces F of the recording heads 17a to 17c.

On the top face of the supporting frame 40, an ink collection tray 44 is arranged which is for collecting waste ink wiped off from the ink ejection surfaces F by the wipers 35. Substantially in the middle of the ink collection tray 44, ink discharge holes (unillustrated) are formed, and parts of the tray faces on opposite sides of the ink discharge holes are inclined downward toward the ink discharge holes. The waste ink having been wiped off from the ink ejection surfaces F by the wipers 35 and having fallen to the tray faces passes toward the ink discharge holes. Then, the waste ink passes through an ink collection passage (unillustrated) coupled to the ink discharge holes and is collected in a waste ink collection tank (unillustrated).

The wipers 35 are, for example, rubber members formed of EPDM for wiping off ink ejected from the ejection nozzles 18 of the recording heads 17a to 17c. The wiper 35 is kept in contact with a wiping start position, by being pressed from substantially the vertical direction, outside a nozzle region R (see FIG. 5) where the ejection nozzles 18 are exposed, and wipes, as the wiper carriage 33 moves, the ink ejection surfaces F including the nozzle region R in a predetermined direction (the direction indicated by arrow C).

As shown in FIG. 12, a total of 12 wipers 35 are arranged, four at each of substantially equally spaced positions in the width direction (the direction indicated by arrows A and A′) of a unit body 31a of the blade unit 31, in three rows in the movement direction (the direction indicated by arrows C and C′) of the wiper carriage 33. The wipers 35 are arranged at positions corresponding to the recording heads 17a to 17c (see FIG. 3) constituting the line heads 11C to 11K. The blade unit 31 is detachably attached to the wiper carriage 33, and when the wipers 35 wear or break, the wipers 35 are replaced together with the unit body 31a.

On both side faces of the unit body 31a that are parallel to the movement direction of the wiper carriage 33, first and second engagement portions 50 and 51 are formed. The first engagement portion 50 is arranged on the upstream side of the second engagement portion 51 in the attachment direction (the direction indicated by arrow C′) of the blade unit 31. The first and second engagement portions 50 and 51 engage respectively with positioning pins 53a and 53b (see FIG. 13) provided on the wiper carriage 33 to determine the position of the blade unit 31 with respect to the wiper carriage 33.

As shown in FIG. 13, the wiper carriage 33 includes a carriage body 33a in a flat-plate shape and rail portions 33b provided at both side end parts of the carriage body 33a. To the carriage body 33a, the blade unit 31 is attached. On the rail portion 33b, the rack 32, the slide pulley 36, positioning pulleys 46, and the positioning pins 53a and 53b are provided. The rack 32 is provided along one end edge of the carriage body 33a and meshes with the rack driving gear 47 on the supporting frame 40. The slide pulleys 36 make contact with the rail grooves 41 formed in the supporting frame 40.

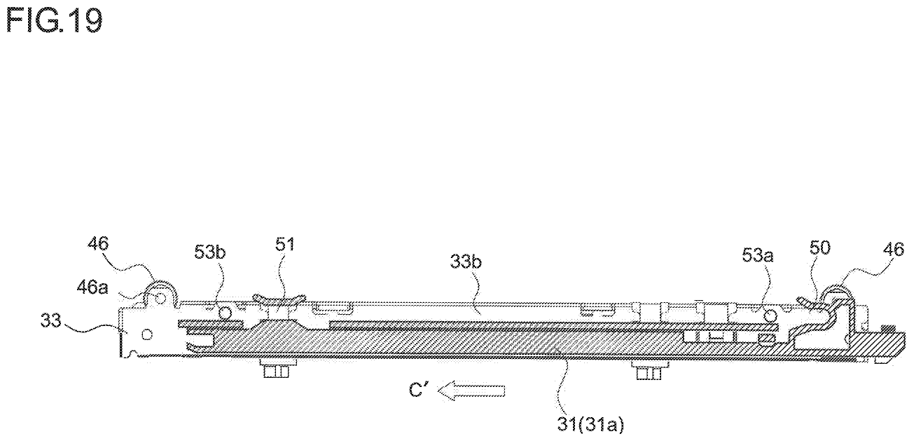

The positioning pulleys 46 are provided at four places on the top face of the carriage body 33a. The positioning pulleys 46 are rotatably fitted around the pivot shafts 46a (see FIG. 19) provided on the rail portion 33b. When the supporting frame 40 is raised toward the recording portion 9 side to wipe the ink ejection surfaces F of the recording heads 17a to 17c, the positioning pulleys 46 make contact with the head housing 10 of the recording portion 9 and thereby keep a predetermined contact state between the wipers 35 and the ink ejection surfaces F.

The positioning pins 53a and 53b protrude from the inner side faces of the rail portion 33b and are engaged with the first and second engagement portions 50 and 51 on the blade unit 31.

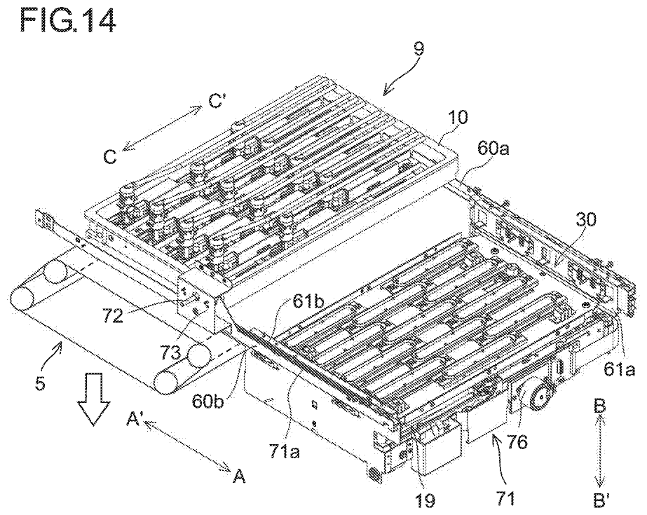

Now, a description will be given of recovery operation for the recording heads 17a to 17c in the printer 100 according to this embodiment. When recovery operation for the recording heads 17a to 17c is performed by the maintenance unit 19, as shown in FIG. 14, the first belt conveying portion 5 which is arranged opposite the bottom face of the recording portion 9 is lowered. Then, as shown in FIG. 15, with the cap unit 30 left in the second position, the unit moving mechanism moves the maintenance unit 19 from the second position to the first position.

Then, prior to wiping operation, ink is fed to the recording heads 17a to 17c. The fed ink 22 is forcibly ejected (purged) from the ejection nozzles 18 (see FIG. 16). Through this purging operation, ink with high viscosity, foreign matter, and bubbles in the ejection nozzles 18 are discharged and it is thus possible to achieve recovery of the recording heads 17a to 17c.

Next, wiping operation is performed to wipe the ink 22 discharged onto the ink ejection surfaces F. Specifically, as shown in FIG. 16, the maintenance unit 19 is raised by the unit lifting mechanism 70 so that the wipers 35 are kept in pressed contact with a wiping start position on the ink ejection surface F of the recording heads 17a to 17c.

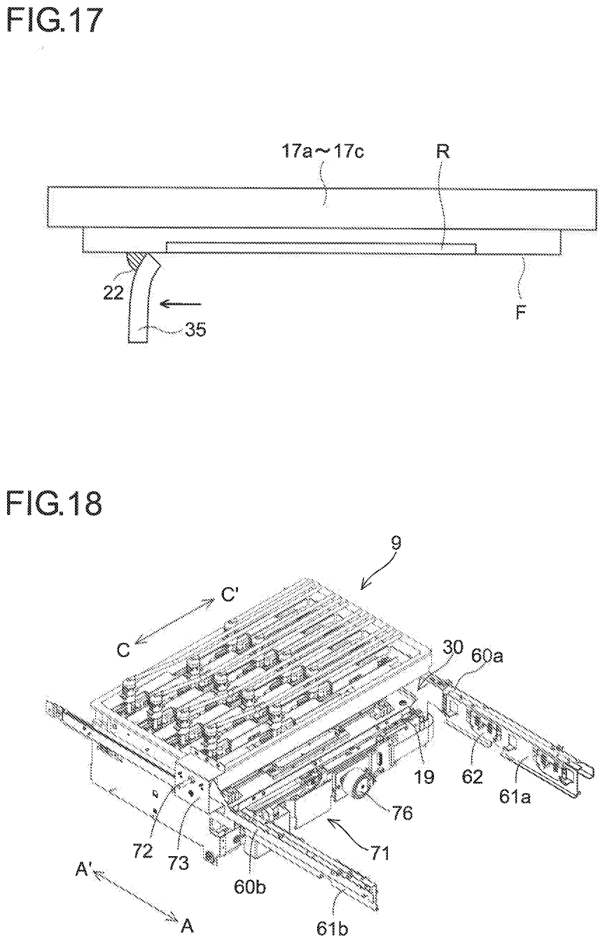

Then, the wiper carriage 33 is horizontally moved in the direction indicated by arrow C by the wiper driving motor 45 (see FIG. 11) so that, as shown in FIG. 17, the wipers 35 wipe off the ink 22 ejected onto the ink ejection surfaces F of the recording heads 17a to 17c.

After the wipers 35 move to the downstream side end part of the ink ejection surfaces F of the recording heads 17a to 17c, the unit lifting mechanism 70 lowers the wiper carriage 33. Thus, the wipers 35 are retracted downward away from the ink ejection surfaces F of the recording heads 17a to 17c.

Then, the unit moving mechanism moves the maintenance unit 19 from the first position in the direction indicated by arrow A. Thus, as shown in FIG. 14, the maintenance unit 19 is arranged in a predetermined position (second position) right under the cap unit 30.

Now, a description will be given of operation in which the cap unit 30 is attached to the recording heads 17a to 17c in the printer 100 according to this embodiment. When the cap unit 30 caps the recording heads 17a to 17c, as shown in FIG. 14, the first belt conveying portion 5 which is arranged opposite the bottom face of the recording portion 9 is lowered.

Then, as shown in FIG. 18, with the cap unit 30 arranged over the maintenance unit 19, the maintenance unit 19 and the cap unit 30 are moved from the second position to the first position by the unit moving mechanism. Thereafter, the maintenance unit 19 and the cap unit 30 are raised by the unit lifting mechanism 70 so that the cap unit 30 (cap part 30b) is attached to the recording heads 17a to 17c.

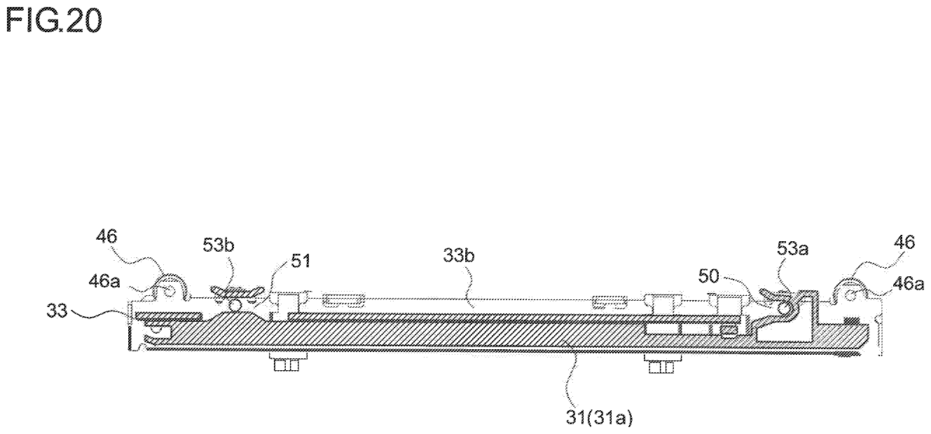

Next, how the blade unit 31 is fitted to the wiper carriage 33 will be described. FIG. 19 is a side sectional view showing a state where the blade unit 31 is in the process of being fitted to the wiper carriage 33, and FIG. 20 is a side sectional view showing a state where the fitting of the blade unit 31 to the wiper carriage 33 is complete. For the sake of convenience of description, the blade unit 31 is indicated by hatching. The wipers 35 fixed in the blade unit 31 are omitted from illustration.

First, as shown in FIG. 19, from one end side (in FIG. 13, the lower left side) of the wiper carriage 33, one end side (in FIG. 12, the upper right side) of the blade unit 31 is inserted in the direction indicated by arrow C′ along the carriage body 33a and the rail portion 33b.

When the blade unit 31 is inserted up to a predetermined position, as shown in FIG. 20, the first engagement portion 50 formed on the unit body 31a of the blade unit 31 engages with the positioning pin 53a provided on the wiper carriage 33. Likewise, the second engagement portion 51 formed on the unit body 31a engages with the positioning pin 53b. Thus, the blade unit 31 is fixed to the wiper carriage 33 in the up-down direction. That is, the blade unit 31 is positioned with respect to the wiper carriage 33 in the up-down direction.

Here, for example, consider a case where the blade unit 31 makes contact with the bottom face of the carriage body 33a and is thereby positioned. The carriage body 33a is formed by bending a metal plate a plurality of times and thus has a larger part tolerance than the rail part 33b. Thus, the part tolerance (bending tolerance) accumulates and results in a larger fitting tolerance of the blade unit 31 with respect to the positioning pulleys 46 in the up-down direction. As a result, the variation of the amount of interference (the amount of overlap) of the wipers 35 with the ink ejection surfaces F of the recording heads 17a to 17c exceeds the permissible value; this may inconveniently cause ink wiping failure or damage to the wipers 35.

With the configuration according to this embodiment, the positioning pin 53a and the pivot shaft 46a of the positioning pulley 46 are both fixed to the same face (inner side face) of the rail portion 33b. Thus, with the engagement of the first engagement portion 50 with the positioning pin 53a and the engagement of the second engagement portion 51 with the positioning pin 53b, it is easier to attain satisfactory accuracy in the position of the blade unit 31 with respect to the positioning pulleys 46 in the up-down direction.

It is thus possible to minimize the variation of the amount of interference (the amount of overlap) of the wipers 35 with the ink ejection surfaces F of the recording heads 17a to 17c, and it is thereby possible to efficiently suppress ink wiping failure or damage to the wipers 35 due to variation of the amount of interfering of the wipers 35.

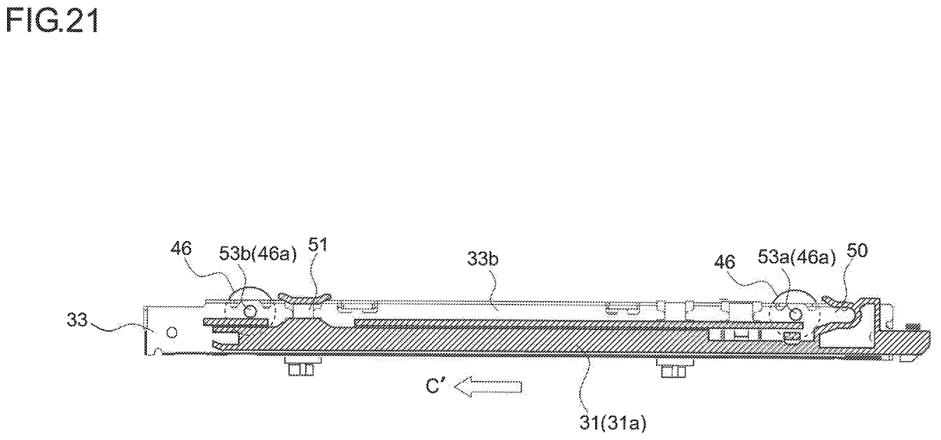

FIG. 21 is a side sectional view showing a state where the blade unit 31 is in the process of being fitted to the wiper carriage 33 in the maintenance unit 19 according to a second embodiment of the present disclosure, and FIG. 20 is a side sectional view showing a state where the fitting of the blade unit 31 to the wiper carriage 33 is complete.

In this embodiment, in the rail portion 33b of the wiper carriage 33, the positioning pins 53a and 53b are coaxial with the pivot shafts 46a of the positioning pulleys 46. That is, the pivot shafts 46a of the positioning pulleys 46 double as the positioning pins 53. In other respects, the structure of the maintenance unit 19 is similar to that in the first embodiment.

With the configuration according to this embodiment, the first and second engagement portions 50 and 51 on the blade unit 31 engage respectively with the positioning pins 53a and 53b which are coaxial with the pivot shafts 46a of the positioning pulleys 46. Thus, the blade unit 31 is directly positioned at the pivot shafts 46a of the positioning pulleys 46, and this helps further improve the positional accuracy of the blade unit 31 with respect to the positioning pulleys 46 in the up-down direction compared with the first embodiment.

The present disclosure may be implemented in any other manner than in the embodiment described above, and allows for many modifications without departure from the spirit of the present disclosure. For example, any other conventionally well-known driving mechanism can be used as the unit moving mechanism composed of the driving motor 72, the gear train, and the like, and as the unit lifting mechanism 70 composed of the wipe lifting motor 76, the gear train, the rotary shaft 75, the supporting arms 74, and the like.

The number of ejection nozzles 18 in the recording heads 17a to 17c, the interval between the nozzles, and the like can be set as necessary according to the specifications of the printer 100. There are also no particular restrictions on the number of recording heads; for example, for each line heads 11C to 11K, one, two, or more than four recording heads can be arranged.

The present disclosure finds application in recording head maintenance devices that horizontally move, by use of a rack and a rack driving gear, a wiper that wipes the ink ejection surface of the recording head. Based on the present disclosure, it is possible to provide a recording head maintenance device that can keep a predetermined distance between a rack provided on a carriage to which a wiper is fixed and a rack driving gear transmitting a driving force to the rack with a simple configuration.

What is claimed is:

1. A recording head maintenance device, comprising:
a wiper which wipes an ink ejection surface of a recording head that ejects ink onto a recording medium;
a blade unit to which the wiper is fixed;
a wiper carriage which supports the blade unit such that the blade unit is attachable and detachable in a horizontal direction;
a supporting frame which supports the wiper carriage such that the wiper carriage is movable in the horizontal direction;
a wiper moving mechanism which makes the wiper carriage reciprocate along the supporting frame; and
a unit lifting mechanism which makes the supporting frame together with the wiper carriage move up and down in directions approaching and receding from the ink ejection surface,
the recording head maintenance device performing wiping of the ink ejection surface by making the wiper carriage reciprocate and move up and down,
wherein
the wiper carriage includes
a carriage body in a flat-plate shape;
a pair of rail portions provided at both side end parts of the carriage body that are parallel to a movement direction of the wiper carriage;
positioning pins protruding horizontally from inner side faces of the pair of rail portions respectively; and
positioning pulleys provided rotatably on the pair of rail portions respectively, the positioning pulleys making contact with a head housing holding the recording head, thereby to keep a gap between the wiper and the ink ejection surface constant, and
the blade unit has, on both side faces thereof facing the pair of rail portions, engagement portions that engage with the positioning pins so as to hold the positioning pins from above and below.

2. The recording head maintenance device according to claim 1, wherein
pivot shafts of the positioning pulleys are fixed to the inner side faces of the pair of rail portions respectively.

3. The recording head maintenance device according to claim 2, wherein
the positioning pins are coaxial with the pivot shafts of the positioning pulleys.

4. The recording head maintenance device according to claim 1, wherein
the positioning pins are provided one at each end part of each of the rail portions in the movement direction of the wiper carriage, and
the engagement portions comprise a first engagement portion that engages with one of the positioning pins and a second engagement portion that engages with another of the positioning pins.

5. The recording head maintenance device according to claim 1, wherein
a plurality of the wipers are fixed to the blade unit, and
as the wiper carriage is made to reciprocate and move up and down, the wiping of the ink ejection surface is performed for a plurality of the recording heads.

6. An inkjet recording apparatus, comprising:
a recording medium conveying portion which conveys a recording medium;
a recording portion in which a recording head that ejects ink onto the recording medium conveyed by the recording medium conveying portion is arranged; and
the recording head maintenance device according to claim 1 which performs wiping of an ink ejection surface of the recording head arranged in the recording portion.
